(19) United States
(12) Patent Application Publication
(10) Pub. No.: US 2025/0145121 A1
(43) Pub. Date: May 8, 2025

(54) AN ALIGNMENT SYSTEM FOR USE IN COUPLING A WORK MACHINE SYSTEM COMPRISING INTERCHANGEABLE TRAILER UNITS

(71) Applicant: Caterpillar SARL, Geneva (CH)

(72) Inventor: Stephen HERD, Durham (GB)

(73) Assignee: Caterpillar SARL, Geneva (CH)

(21) Appl. No.: 18/865,829

(22) PCT Filed: May 23, 2023
(86) PCT No.: PCT/EP2023/025239

§ 371 Date: Nov. 14, 2024

(30) Foreign Application Priority Data
May 27, 2022 (GB) 2207872.9

(51) Int. Cl. B60S 13/02; B62D 53/00

(52) U.S. Cl. CPC B60S 13/02; B62D 53/00

(57) ABSTRACT

The work machine system comprises a tractor unit releasably connectable to interchangeable trailer units by a coupling. When a trailer unit is coupled to the tractor unit a work machine is formed for performing work functions. The tractor unit may not be capable of movement between trailer units when uncoupled, for example because it comprises only one pair of wheels rotating about a single axis and as such would tip over without support. The alignment system comprises a platform for supporting and holding the tractor unit thereon and a platform transport system to move the platform relative to the trailer units. Therefore, alignment for coupling between the tractor and trailer units can be achieved.

### TECHNICAL FIELD

This disclosure is directed towards an alignment system for use in coupling a work machine system comprising interchangeable trailer units, an apparatus comprising the alignment system and work machine system and a method of operating such an apparatus.

### BACKGROUND

Machines, such as articulated machines and/or off-highway vehicles including articulated trucks, scrapers (such as wheel tractor scrapers) and mining trucks (particularly underground mining trucks), commonly comprise a tractor unit connected to a trailer unit. These machines comprise one or more articulated joints allowing for articulation between the tractor and trailer units (e.g. for steering) and/or oscillation between the tractor and trailer units (e.g. as the tractor and trailer units independently roll at different angles as they move over a rough terrain). Commonly, the tractor comprises either a single axle or only two ground engaging components, wheels or the like, and as such, is stabilized by the articulated connection with the trailer.

The tractor and trailer units are permanently coupled to each another about the joint and are fully integrated with one another so that the machine is purposively designed to perform a certain range of tasks. As a result, for example, the units of an articulated truck may be designed to receive material from an excavator and transport such material in an open worksite, the units of a mining truck may be designed to transport material in an underground mine and the units of a wheel tractor scraper may be designed to collect material itself and transport the material around a worksite. Yet furthermore, the tractor and trailer units of articulated trucks may be designed for specific uses, such as by having a dump body or ejector body, for carrying containers, water, cable reels or fuel, for operating as a hooklift or by having high capacity bodies for coal or waste and so on.

Worksites therefore often require a number of different work machines to suit different applications. Whilst such an approach ensures that an appropriate and efficient machine for a certain task is selected, it can mean that some types of machines remain idle on a worksite when they are not required, meaning they have a low rate of utilisation. In addition, it is often complex, time intensive and costly to design and manufacture a dedicated machine, including both its tractor and trailer unit, in order to fulfil a specific user requirement.

### SUMMARY

The present disclosure provides an apparatus, alignment system and method in accordance with the claims. The present disclosure is generally directed towards an apparatus comprising an alignment system and a work machine system, the alignment system and a method of operating the apparatus. The work machine system comprises a tractor unit releasably connectable to interchangeable trailer units by a coupling. When a trailer unit is coupled to the tractor unit a work machine is formed for performing work functions. The tractor unit may not be capable of movement between trailer units when uncoupled, for example because it comprises only one pair of wheels rotating about a single axis and as such would tip over without support. The tractor unit may comprise two ground engagers and in some aspects the two ground engagers may be coupled with a single axle. The alignment system comprises a platform for supporting and holding the tractor unit thereon and a platform transport system to move the platform relative to the trailer units. Therefore, alignment for coupling between the tractor and trailer units can be achieved.

As tractor and trailer unit may not be independently moveable about, it may not be possible to align them for coupling without an external transport system. The apparatus and alignment system of the present disclosure enable the trailer unit to be moved into position such that it is aligned with and can be coupled to a trailer unit. As a result, trailer units can be interchanged on a worksite or the like.

The alignment system is for use in coupling a work machine system comprising a plurality of interchangeable trailer units and a tractor unit for coupling to each of the trailer units to form a work machine. The alignment system comprises a storage area comprising a plurality of storage stations, each storage station being for receiving a trailer unit. A platform is adjacent to the storage area and is for receiving and supporting the tractor unit. A platform transport system conveys the platform into alignment with each of the storage stations for aligning the tractor unit mounted on the platform with an adjacent trailer unit. Thus the tractor unit can be releasably coupled to the adjacent trailer unit.

The apparatus comprises the alignment system and the work machine system. The plurality of interchangeable trailer units are located in the storage stations and the tractor unit is located on the platform.

The method if for operating the apparatus and comprises operating a work machine comprising the tractor unit coupled to a first trailer unit of the plurality of trailer units so as to mount the tractor unit on the platform and locate the first trailer unit in the storage area. The tractor unit is decoupled from the first trailer unit. The platform transport system is operated to move the platform and tractor unit mounted thereon relative to the storage area until the tractor unit is aligned with a second trailer unit of the plurality of trailer units in the storage area. The tractor unit is coupled to the second trailer unit.

### BRIEF DESCRIPTION OF THE DRAWINGS

By way of example only, embodiments of systems, apparatuses and methods of the present disclosure are now described with reference to, and as shown in, the accompanying drawings, in which:

FIG. 1 is a schematic view of an apparatus comprising an alignment system and work machine system of the present disclosure; and

FIG. 2 is a magnified view of a further embodiment of the apparatus of FIG. 1 illustrating an embodiment of an alignment identification arrangement.

### DETAILED DESCRIPTION

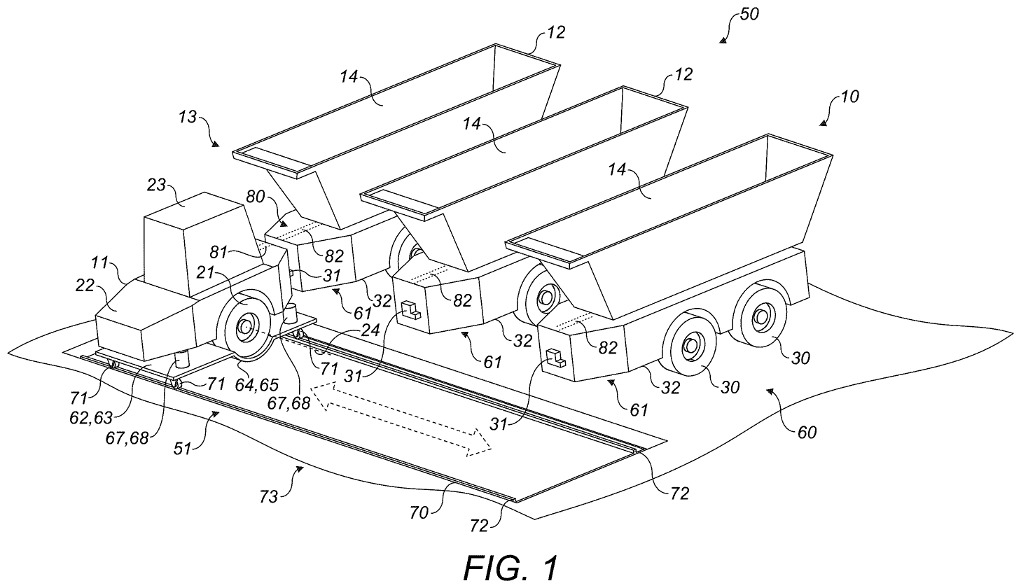

FIG. 1 schematically illustrates an apparatus 50 comprising an alignment system 51 and a work machine system 10 of the present disclosure. The work machine system 10 comprises a tractor unit 11 and a plurality of interchangeable trailer units 12. The tractor unit 11 is coupleable to each of the trailer units 12 and a work machine 13 is formed by the tractor unit 11 being coupled to one of the trailer units 12. The work machine 13 formed from the tractor unit 11 and one of the trailer units 12 may be configured for off-highway operation and/or the tractor and trailer units 11, 12 comprise off-highway wheels or tracks mounted to an off-highway suspension system. The work machine 13 may be an earth moving machine.

In general, each of the tractor and trailer units 11, 12 are not designed as stand alone vehicles and serve no practical purpose in isolation. However, once coupled together, the tractor and trailer units 11, 12 together form a fully integrated work machine 13. The tractor unit 11 may comprise a pair of ground engagers 21. In such embodiments, the tractor unit 11 is unstable unless coupled with the trailer unit 12. In some embodiments, the tractor unit 11 may comprise a tractor of an articulated truck and the trailer unit 12 may comprise a trailer for hauling material on a worksite.

The tractor unit 11 comprises a tractor coupling (not shown in FIG. 1) and at least one tractor ground engager 21 driven by a tractor power system (not shown in FIG. 1). The tractor unit 11 may alternatively be referred to as a drive unit and generally refers to the unit that provides the main driving power to the work machine 13. The tractor power system may comprise a power source, for example an internal combustion engine, a turbine, a fuel cell or a battery, for providing power to drive the at least one tractor ground engager 21, for example via a power train and/or motor.

The tractor unit 11 may comprise a main body 22, which may comprise a cab 23 for an operator. The cab 23 may comprise the operator controls for controlling the work machine 13. The at least one ground engager 21, tractor power system and tractor coupling may be mounted to the main body 22. The at least one tractor ground engager 21 may be wheels as illustrated or may comprise tracks, a roller or the like. The at least one ground engager 21 may rotate about a tractor rotational axis 24 and may comprise a pair of wheels driven about the tractor rotational axis 24. The pair of wheels may be mounted to a single axle or may have motors mounted directly thereto.

The tractor unit 11 may not be independently moveable about the ground 73 by the tractor power system when the tractor unit 11 is not coupled to a trailer unit 12. When coupled to a trailer unit 12 the tractor unit 11 may be balanced by the trailer unit 12 in an upright position (as shown in FIG. 1) and when not coupled to a trailer unit 12 the tractor unit 11 may be biased away (i.e. tilt over) from the upright position without additional support.

The tractor unit 11 may comprise no further tractor ground 73 engagers in contact with the ground 73 when the work machine 13 is driven across the ground 73, for example comprising only a pair of wheels 21 rotating around the tractor rotational axis 24. The centre of mass of the tractor unit 11 may also be offset from the at least one tractor ground engager 21 and/or tractor rotational axis 24 such that the tractor unit 11 is unbalanced when not coupled to a trailer unit 12. The coupling between the tractor and trailer units 11, 12 may counterbalance rotation of the tractor unit 11 about the tractor rotational axis 24 due to the offset centre of mass.

Each trailer unit 12 comprises at least one trailer ground engager 30 and a trailer coupling 31, which may be mounted to a trailer frame or chassis 32 of the trailer unit 12. Each trailer unit 12 may comprise a haul body or tool for performing work functions. The trailer units 12 may each be different and may be configured for performing different work functions. For example, each trailer unit 12 may comprise at least one haul body or tool comprising a dump body, scraper, ejector body, open container, container for water, fuel, lubricant or the like, cable reel, hooklift, high capacity body for coal or waste, low profile body for underground mining, flat bed, cement mixer, forestry body, shipping container bed, pipe carrier and so on.

As a result, when each trailer unit 12 is coupled to the tractor unit 11 a different work machine 13 with different work functions is formed, such as an articulated truck, a mining truck (such as an underground mining truck) or a scraper (such as a wheel tractor scraper). For example, FIG. 1 illustrates a work machine 13 in the form of an articulated hauler formed by a trailer unit 12 with a dump body 14 being coupled to the tractor unit 11. Thus the same tractor unit 11 can be used to form different work machines 13 and/or perform different work functions by coupling different trailer units 12 thereto.

The at least one trailer ground engager 30 may comprise at least one pair of wheels as illustrated or may comprise tracks, a roller or the like depending upon the work function of the trailer unit 12. At least one of the plurality of trailer units 12 may comprises a trailer power system (not illustrated) connected to and for driving the at least one trailer ground engager 30. For example, the trailer power system may comprise a power transfer system for transferring power mechanically (via a power train) or electrically (via an electrical system and at least one motor) to the at least one trailer ground engager 30.

The at least one trailer unit 12 may not be independently moveable about a terrain, even if present by the trailer power system, when the tractor unit 11 is not coupled to the at least one trailer unit 12. For example, the trailer power system may receive power from the tractor power system via the tractor and trailer couplings 20, 31, as discussed further below. Alternatively, the trailer power system may comprise an independent power source, such as a battery, fuel cell, internal combustion engine and/or turbine for driving the at least one trailer ground engager 30.

The tractor and trailer units 11, 12 are pivotable relative to one another about a tractor-trailer joint (not shown), which may be along a tractor-trailer pivot or articulation axis. In addition, steering of the work machine 13 is achieved by a steering mechanism (not shown) which pivots the tractor and trailer units 11, 12 about the tractor-trailer joint. The tractor and/or trailer units 11, 12 may comprise an oscillation hitch for enabling oscillation of the tractor and trailer units 11, 12 relative to one another when the tractor and trailer couplings 31 are coupled. The oscillation hitch may form part of or be separate to the tractor-trailer joint.

The tractor and trailer couplings 31 may be manually coupleable to one another by an operator, for example by the operator manually locking them together. Alternatively the tractor and trailer couplings 31 may be at least partially automatically controlled to achieve the coupling.

The present disclosure thus provides the alignment system 51 for locating and supporting the tractor unit 11 for coupling to one or more trailer units 12. As illustrated in FIG. 1, the alignment system 51 comprises a storage area 60, which may be a region of the ground 73, a region of a worksite, adjacent to a worksite or the like. The storage area 60 comprises a plurality of storage stations 61, each storage station 61 being for receiving a trailer unit 12. Each storage station 61 may be a designated area for a trailer unit 12. Alternatively, each storage station 61 may be defined as the location of a trailer unit 12 in the storage area 60.

The alignment system 51 further comprises a platform 62 for receiving and supporting the tractor unit 11. The tractor unit 11 may be mountable on the platform 62 by being driven thereon whilst connected to a trailer unit 12. The platform 62 may comprise a platform body 63.

The platform 62 may comprise a holding arrangement 64 for restraining movement of the tractor unit 11 relative to the platform 62 when the tractor unit 11 is mounted on the platform 62. As a result, when the tractor unit 11 is mounted on the platform 62, the platform body 63 may support the weight of the tractor unit 11 whilst the holding arrangement 64 may hold the tractor unit 11 on the platform 62 during movement and when the tractor unit 11 is not coupled to a trailer unit 12.

The holding arrangement 64 may comprise a wheel receiving arrangement 65 for receiving wheels 21 of the tractor unit 11. As illustrated, the wheel receiving arrangement 65 may comprise at least one recess for receiving the wheels 21 of the tractor unit 11. In particular, the circumference of each wheel 21 may be partially located in a recess such that forward and rearward motion of the wheel 21 and tractor unit 11 is prevented unless sufficient driving force is applied to the wheel 21 by the tractor power system.

The platform 62 may comprise a support arrangement 67 for supporting the tractor unit 11 when received on the platform 62 such that the tractor unit 11 remains in the upright position. As the tractor unit 11 is unstable about its tractor rotational axis 24, the support arrangement 67 may prevent the tractor unit 11 from tilting over about the tractor rotational axis 24 when it is uncoupled from the trailer unit 12.

The support arrangement 67 may comprise at least one mount 68 against which the tractor unit 11 rests, as illustrated, or to which the tractor unit 11 is coupled. The at least one mount 68 may extend between the platform body 63 and the tractor unit 11 when the tractor unit 11 is mounted on the platform 62. The at least one mount 68 may comprise at least one post as illustrated. At least one mount 68 may be located on at least one side of the tractor rotational axis 24 for prevent rotation of the tractor unit 11 about the tractor rotational axis 24. The at least one mount 68 may only be located on one side of the tractor rotational axis 24 if the centre of mass of the tractor unit 11 is on the other side of the tractor rotational axis 24. At least one mount 68 may be located on either side of the tractor rotational axis 24 for prevent rotation of the tractor unit 11 in both directions about the tractor rotational axis 24.

The at least one mount 68 may be removably mounted to the platform 62. For example, the at least one mount 68 may be located between the platform body 63 and tractor unit 11 after the tractor unit 11 is driven onto the platform 62 and before the tractor and trailer units 11, 12 are uncoupled. After uncoupling, the at least one mount 68 may prevent the tractor unit 11 from tiling over.

The alignment system 51 further comprises a platform transport system 70 configured to convey the platform 62 into alignment with each of the storage stations 61 and/or trailer units 12 for aligning the tractor unit 11 mounted on the platform 62 with an adjacent trailer unit 12 such that the tractor unit 11 can be releasably coupled to the adjacent trailer unit 12. The platform transport system 70 may be operable to convey the platform 62 to a plurality of locations, each adjacent to a trailer unit 12 and/or storage station 61. As a result, the tractor unit 11 can be moved between the interchangeable trailer units 12 even though the tractor unit 11 cannot itself, independently, move between them.

The platform transport system 70 may extend adjacent to the storage area 60 and may comprise any suitable arrangement for moving the platform 62 relative to the storage area 60. As illustrated, the platform transport system 70 may comprise wheels 71 on the underside of the platform 62 mounted in one or more rails 72. The one or more rails 72 may be mounted directly or indirectly to the ground 73. The wheels 71 may rotate along the rails 72 to move the platform 62 therealong and between the trailer units 12 and/or storage stations 61.

The platform transport system 70 may comprise a platform control system 91, which may include an actuator arrangement, for moving the platform 62 relative to the storage area 60, such as in a transverse direction (i.e. across the line of trailer units 12 and storage stations 61. For example, the at least one motor may be mounted to the platform 62 for driving the wheels 71 to move the platform 62 along the rails 72). Alternatively, the platform transport system 70 may comprise any other suitable actuator arrangement, such as a rack and pinion, a linear actuator or the like. Yet further alternatively, the platform 62 may be manually moveable by one or more operators relative to the storage area 60.

In embodiments, the tractor power system may supply power to operate the platform transportation system 70. In particular, the tractor power system may be releasable electrically connectable to the platform transportation system 70 to supply electrical power for operation of the platform transportation system 70, such as by powering the at least one motor.

Although not illustrated, in embodiments, the platform transport system 70 may also be moveable in a longitudinal direction, which may be perpendicular to the transverse direction and towards/away from the trailer units 12 and storage stations 61. The platform transport system 70 may therefore be operable to move the tractor unit 11 towards and away from the trailer units 12 for alignment and coupling. For example, the actuator arrangement may be for moving the platform 62 relative to the storage area 60 in the transverse and longitudinal directions, for example by moving the platform 62 on rails or on the ground towards and away from the trailer units 12.

Although not illustrated, in embodiments the platform transport system 70 may also comprise a height adjustment arrangement for changing the height (i.e. distance from the ground) of the platform 62. Therefore, the height adjustment arrangement may be configured to change the height of the tractor unit 11 mounted thereon, thereby enabling alignment for coupling in the height direction as well.

The apparatus 50, alignment system 51 and/or work machine system 10 may further comprise an alignment identification arrangement 80 for identifying the alignment of the platform 62 relative to each of the storage stations 61 and/or trailer units 12 such that the tractor unit 11 on the platform 62 can be aligned for coupling with the trailer units 12. For example, as illustrated in FIG. 1, the alignment identification arrangement 80 may comprise a tractor marking 81 on the tractor unit 11 and a trailer marking 82 on each trailer unit 12 which, when aligned by movement of the platform 62 relative to the trailer units 12, identify that the tractor unit 11 is in the correct position for coupling with the adjacent trailer unit 12.

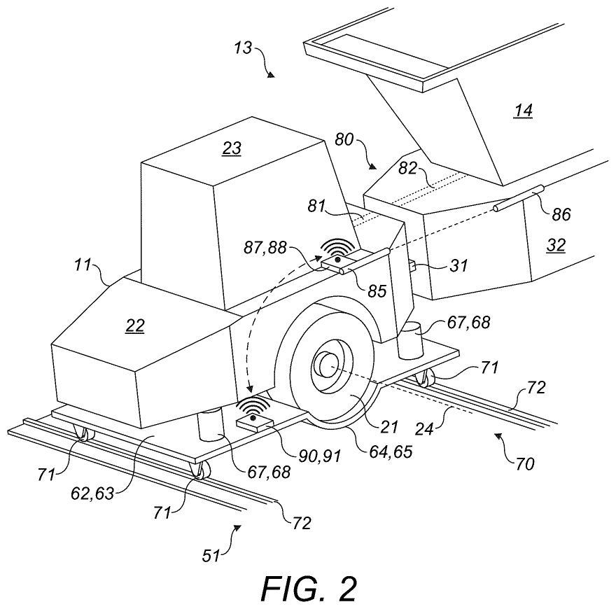

The alignment identification arrangement 80 may comprise at least one sensor 85 for identifying alignment between the tractor and trailer units 11, 12. As illustrated in FIG. 2, at least one sensor 85 may be mounted to the tractor unit 11 and may be configured to identify if the trailer unit 12 is aligned for coupling with the tractor unit 11. The trailer unit 12 may comprise a trailer identifier 86, which may be a marking, sensor, transceiver, identification tag or the like at the at least one sensor 85 may be configured to detect the trailer identifier 86 so as to identify if the trailer unit 12 is aligned for coupling with the tractor unit 11. The trailer identifier 86 may form part of a trailer control system.

The alignment identification arrangement 80 may comprise an alignment identification communication module 87 for communicating alignment information to the platform transport system 70. The alignment identification communication module 87 may be configured for wireless communication and may, along with the at least one sensor 85, be connected or form part of a tractor control system 88 of the tractor unit 11. The tractor control system 88 may control the operation of the tractor unit 11, such as the tractor power system, and may receive inputs from the operator in the cab 23.

The platform transport system 70 may comprise a platform communication module 90 for receiving the alignment information from the alignment identification communication module 87. The platform communication module 90 may form part of or be connected to the platform control system 91. The platform control system 91 may be configured to receive the alignment information from the platform communication module 90 and control the actuator arrangement for moving the platform 62. In particular, if the alignment information indicates that the tractor and trailer units 11, 12 are not aligned for coupling then the platform control system 91 may operate the actuator arrangement until the tractor and trailer units 11, 12 are aligned for coupling.

The alignment identification arrangement 80 may also be operable to perform an authentication operation to ensure that there is permission for the trailer unit 12 to connect to and be operated by the tractor unit 11. The authentication operation may be utilised as a compatibility feature such that the trailer units 12 can be identified in a database on a remote computer system and trailer units 12 connected to a tractor unit 11 can be checked against the database and, if found to be compatible on the database, coupling and/or operation of the trailer unit 12 and/or platform transport system 70 may be enabled. The tractor control system 88 may store an authentication codes and upon coupling of the tractor unit 11 to the trailer unit 12 the tractor unit control system may exchange authentication signals with the trailer unit control system to determine whether to authenticate the trailer unit control system.

### INDUSTRIAL APPLICABILITY

The present disclosure further provides a method of operating the aforementioned apparatus 50, including changing the trailer unit 12 attached to a tractor unit 11. A work machine 13, comprising a tractor unit 11 having an interchangeable first trailer unit 12 coupled thereto, may be driven such that the tractor unit 11 rides onto the platform 62 and the first trailer unit 12 is in the storage area 60, such as in a particular storage station 61. The tractor unit 11 may ride onto the platform 62 such that the holding arrangement 64 restrains forward and rearward movement of the tractor unit 11 from the platform 62. For example, the wheels 21 of the tractor unit 11 may be mounted in at least one recess of the wheel receiving arrangement 65.

The tractor unit 11 may also be supported on the platform 62 by the support arrangement 67. For example, the at least one mount 68 may be located between the platform body 63 and tractor unit 11 for maintaining the tractor unit 11 in the upright position (i.e. the upright position the tractor unit 11 remains in when coupled to the trailer unit 12). The at least one mount 68 may be manually located as such or, alternatively, may be automatically actuated into position, for example by extending upwardly from the platform body 63.

Subsequently, the tractor and trailer units 11, 12 may be uncoupled from one another. Such uncoupling is achieved by disconnecting the tractor and trailer couplings 31 from one another, which may be manual or automatically controlled, for example via the tractor control system 88. Once uncoupled, the tractor and trailer units 11, 12 may not be independently moveable. In particular, the tractor unit 11 may tilt over without the support of the support arrangement 67 and the trailer units 12 may not have an independent drive system to move it around.

In order to connect the tractor unit 11 to a second trailer unit 12, the platform transport system 70 may be operated to move the tractor unit 11 into alignment with the further trailer unit 12. For example, the platform 62 may be manually moved into position or the actuator arrangement may be operated until the platform 62 is in position. The alignment identification arrangement 80 may be used to identify when the tractor and trailer units 11, 12 are aligned for coupling.

The alignment identification arrangement 80 may be used to automatically move the platform 62 so that the tractor unit 11 is aligned with a preselected second trailer unit 12. For example, the operator in the cab 23 may input into the tractor control system 88 which second trailer unit 12 they wish to couple to the tractor unit 11. The tractor control system 88 may subsequently issue control signals to the platform transport system 70, for example via the communications modules 88, 90, to move the platform 62 accordingly. The tractor control system 88 may utilise feedback regarding the position of the tractor unit 11 relative to the second trailer unit 12 from the alignment identification arrangement 80 to control the movement of the platform 62 such that alignment for coupling is achieved.

Once the tractor coupling is aligned with the trailer coupling 31 of the further trailer unit 12 they may be coupled together to form a further work machine 13. Such coupling may be achieved manually or by being automatically controlled, for example via the tractor control system 88. The further work machine 13 may be for performing different work functions to that of the initial work machine 13. The support arrangement 67 may be removed as it is no longer necessary because the second trailer unit 12 provides the requisite balance to the tractor unit 11. The newly formed work machine 13 may then be driven out of the holding arrangement 64 and off the platform 62 for performing work on a worksite.

1. An alignment system for use in coupling a work machine system, the work machine system comprising:
a plurality of interchangeable trailer units; and
a tractor unit for coupling to each of the trailer units to form a work machine, wherein the alignment system comprises:
a storage area comprising a plurality of storage stations, each storage station being for receiving a trailer unit;
a platform adjacent to the storage area for receiving and supporting the tractor unit, the platform comprising a support arrangement for supporting the tractor unit when received on the platform such that the tractor unit remains in an upright position, the support arrangement comprising at least one mount against which the tractor unit rests or to which the tractor unit is coupled; and
a platform transport system configured to convey the platform into alignment with each of the storage stations for aligning the tractor unit mounted on the platform with an adjacent trailer unit such that the tractor unit can be releasably coupled to the adjacent trailer unit.

2. The alignment system as claimed in claim 1 wherein the tractor unit comprises a pair of wheels driven about a tractor rotational axis, wherein:
when coupled to a trailer unit, the tractor unit is balanced by the trailer unit in an upright position; and
when not coupled to a trailer unit the tractor unit is configured to tilt over around the tractor rotational axis out of the upright position without additional support.

3. The alignment system as claimed in claim 1 wherein the alignment system further comprises an alignment identification arrangement for identifying the alignment of the platform relative to each of the storage stations such that the tractor unit on the platform can be aligned for coupling with the trailer units in each storage station.

4. The alignment system as claimed in claim 1 wherein the platform comprises a holding arrangement for restraining movement of the tractor unit relative to the platform.

5. The alignment system as claimed in claim 4 wherein the holding arrangement comprises a wheel receiving arrangement for receiving wheels of the tractor unit.

6. The alignment system as claimed in claim 1 wherein the tractor unit comprises a pair of wheels rotating about a tractor rotational axis and at least one mount is located on at least one side of the tractor rotational axis for preventing rotation of the tractor unit about the wheel rotational axis.

7. The apparatus comprising the alignment system of claim 1 and the work machine system, wherein the plurality of interchangeable trailer units are for locating in the storage stations and the tractor unit is for location on the platform.

8. The apparatus as claimed in claim 7 comprising an alignment identification arrangement for identifying the alignment of the tractor unit on the platform relative to each of the trailer units in the storage stations such that the tractor unit on the platform can be aligned for coupling with the trailer units, wherein the alignment identification arrangement comprises at least one sensor for identifying alignment between the tractor and trailer units.

9. The apparatus as claimed in claim 8 wherein the tractor unit comprises the at least one sensor and the trailer unit comprises a trailer identifier, wherein the at least one sensor is configured to detect the trailer identifier so as to identify if the trailer unit is aligned for coupling with the tractor unit.

10. The apparatus as claimed in claim 8 wherein the alignment identification arrangement comprises an alignment identification communication module for communicating alignment information from the at least one sensor to a platform communication module of a platform control system of the platform transport system, wherein the platform control system is configured to control an actuator arrangement of the platform transport system to move the platform based upon the alignment information.

11. A method of operating an apparatus comprising a work machine system and an alignment system, the work machine system comprising a tractor unit coupleable to a plurality of interchangeable trailer units and the alignment system comprising a storage area and an adjacent platform moveable by a platform transport system, the platform comprising a support arrangement for supporting the tractor unit when received on the platform such that the tractor unit remains in an upright position, the support arrangement comprising at least one mount against which the tractor unit rests or to which the tractor unit is coupled, wherein the method comprises:
operating a work machine of the work machine system comprising the tractor unit coupled to a first trailer unit of the plurality of trailer units so as to mount the tractor unit on the platform and locate the first trailer unit in the storage area;
decoupling the tractor unit from the first trailer unit;
operating the platform transport system to move the platform and tractor unit mounted thereon relative to the storage area until the tractor unit is aligned with a second trailer unit of the plurality of trailer units in the storage area; and
coupling the tractor unit to the second trailer unit.

12. The method as claimed in claim 11 wherein the support system is for supporting the tractor unit in the upright position when uncoupled from the first and second trailer units, without which the tractor unit would tilt over from the upright position, wherein the upright position is the orientation of the tractor unit when coupled to the first or second trailer unit.

13. The method as claimed in claim 11 wherein the apparatus comprises an alignment identification arrangement for identifying alignment between the tractor unit and plurality of trailer units and the platform transport system is configured to move the platform to bring the tractor unit into alignment with the second trailer unit based upon alignment information from the alignment identification arrangement.
